(19) United States
(12) Patent Application Publication
(10) Pub. No.: US 2024/0061138 A1
(43) Pub. Date: Feb. 22, 2024

(54) Method to Generate Seismic S Waves and Love Waves Using Inclined Explosive Charges

(71) Applicant: Board of Regents, The University of Texas System, Austin, TX (US)

(72) Inventor: Steven H. Harder, El Paso, TX (US)

(21) Appl. No.: 18/448,426

(22) Filed: Aug. 11, 2023

Related U.S. Application Data
(60) Provisional application No. 63/399,568, filed on Aug. 19, 2022.

(51) Int. Cl. G01V 1/42; G01V 1/44

(52) U.S. Cl. CPC G01V 1/42; G01V 1/44

(57) ABSTRACT

Certain embodiments are directed to seismic survey systems for generating S-waves and Love waves for seismic exploration using explosives in inclined holes. The direction in which the inclined hole is drilled controls the azimuthal polarization of the S-waves generated. The explosive needs to be placed tightly into the borehole eliminating fluids from around the charge or alternatively grouted and stemmed to eliminate fluids.

### CROSS-REFERENCE TO RELATED APPLICATION

Referring to the application data sheet filed herewith, this application claims the benefit of priority under 35 U.S.C. 119(e) from co-pending provisional patent application U.S. Application No. 63/399,568, filed Aug. 19, 2022, the entire contents of which are hereby expressly incorporated herein by reference for all purposes.

### FIELD OF THE INVENTION

Embodiments of the invention are directed to the field of geology and seismology, particular the field of seismic survey methods.

### BACKGROUND

Seismology is the most effective method to image the internal structure of the earth. It is used for petroleum exploration, engineering studies, and to image the deepest structures in the earth. Seismic exploration methods also yield geological information about the properties of the rocks in the subsurface including seismic wave velocities and the acoustic impedance of geological rock formations. There are two basic types of seismic waves, body waves and surface waves. Body waves are the most useful for exploration and imaging because they propagate through the earth, however surface waves propagating along the surface of the earth are useful in detecting certain types of structures near the surface.

There are two types of seismic body waves which propagate in the earth, P-waves, and S-waves. P-waves have a vibration direction or polarization nearly parallel to the direction in which they propagate. S-waves have a polarization nearly perpendicular to the direction of propagation and can have a second polarization which is perpendicular to both the P-wave polarization and the other S-wave polarization. In exploration seismology both types of body waves are generated by artificial sources either explosive or mechanical. There are many mechanical sources that can generate both P-waves and S-waves, but these sources have significant limitations in the amount of power they impart to the earth and their accessibility to locations in rugged terrain. Explosive sources usually required drilling into the earth, however they can impart large amounts of power to earth in a very short time and can be transported to locations in rugged terrain with helicopters, making them useful in a wider range of applications. In addition to body waves that propagate deep in the earth, explosions also generate surface waves, particularly Rayleigh waves with elliptic motion and if horizontal motion is excited, Love waves with horizontally polarized motion. Love waves along with Rayleigh waves are used to define near-surface structures that are often invisible to body wave seismology.

There is often a false impression that explosive sources generate mostly P-wave energy and are not useful for generating S-waves, which is often true for explosive sources in vertical drill holes. However, theoretical seismology indicates that explosions in vertical cylindrical boreholes generate large amplitude S-waves, amplitudes even larger than P-wave amplitudes from the same shot (Heelan, 1953; Hazebroek, 1966; Abo-Zena, 1977; Fehler and Pearson, 1984). The problem is that these S-waves propagate in directions that are not useful for exploration seismology and have vertical polarizations with no horizontal components.

### SUMMARY

The current invention solves the problem of non-useful vertically polarized S-waves by positioning the seismic source at an incline generating useful S-waves. Certain embodiments are directed to seismic survey systems for generating S-waves and Love waves for seismic exploration using explosives in inclined holes. The direction in which the inclined hole is drilled controls the azimuthal polarization of the S-waves generated. The explosive needs to be placed tightly into the borehole eliminating fluids from around the charge or alternatively grouted and stemmed to eliminate fluids. This method does not have the power limitations of mechanical sources.

In certain aspects the explosive charge is positioned at an incline (defined as the angle between the long axis of the explosive charge and a perpendicular or vertical) of between 5, 10, 15, 20, 25, 30, 35, 40 and 50, 55, 60, 70, 75, 80, 85, 90 degrees. In particular aspects the incline is between 20 and 70 degrees, 30 and 60 degrees, 40 and 50 degrees. In certain aspects the incline is 45±5 degrees. The incline can be formed in the terminal portion of the borehole. The explosive charge can vary in size, type and shape. In certain aspects the explosive charge will have a radius of 5, 10, 20, 30, 40, 50, 60, 70, 80, 100 cm or more and a length of 5, 50, 100, 150, 200, 250, 300, 350, 400, 450, 500 cm or longer. In certain aspects the charge will have a length to diameter aspect ratio of 1, 2, 3, 4, 5, 6, 7, 8, 9, 10, 20, 30, 40, 50 or more. In certain aspects the borehole is straight, angled, or curved.

The term “azimuth” refers to an angular measurement in a spherical coordinate system. The vector from an observer to a point of interest is projected perpendicularly onto a reference plane; the angle between the projected vector and a reference vector on the reference plane is the azimuth.

A Love wave is a major type of surface wave having a horizontal motion that is transverse to the direction of propagation (travel).

An S-waves is a wave having a polarization nearly perpendicular to the direction of propagation and can have a second polarization which is perpendicular to both the P-wave polarization and the other S-wave polarization. S-waves carry energy through the Earth in as transverse (crosswise) waves.

The term “securing an explosive source” refers to forming a tight fit of the explosive source in the borehole which can be accomplished by one or more of (i) removing fluid (gas or liquid) from the vicinity of the explosive source, (ii) introducing stemming material, (iii) introducing a grouting material, or (iv) providing an inert wedge to secure the explosive source. Securing the explosive source can be accomplished by grouting or stemming the explosive source within the borehole.

Stemming is the process in which material is placed into a bored blast hole on top of the explosive charge to contain or confine the explosive energy. Stemming the borehole keeps the blast energy from escaping out of the hole and concentrates the explosive energy within the blast hole.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps), but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 Illustrative cross-section showing inclined borehole with explosive and surface receiver array.

FIG. 2 Cross-section in the sagittal plane of directivity of P-wave and S-wave amplitudes from an inclined cylindrical explosive shown at center.

FIG. 3 Raypaths of seismic waves leaving a seismic shot at center being reflected and refracted in the subsurface.

FIG. 4 Lower hemisphere of S-wave directivity from a charge inclined at 45 degrees from vertical.

FIG. 5 An illustrative seismic recording system.

FIG. 6 Seismic traces obtained from recording system similar to that in FIG. 5.

### DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to imply that the scope of the disclosure, including the claims, is limited to that embodiment.

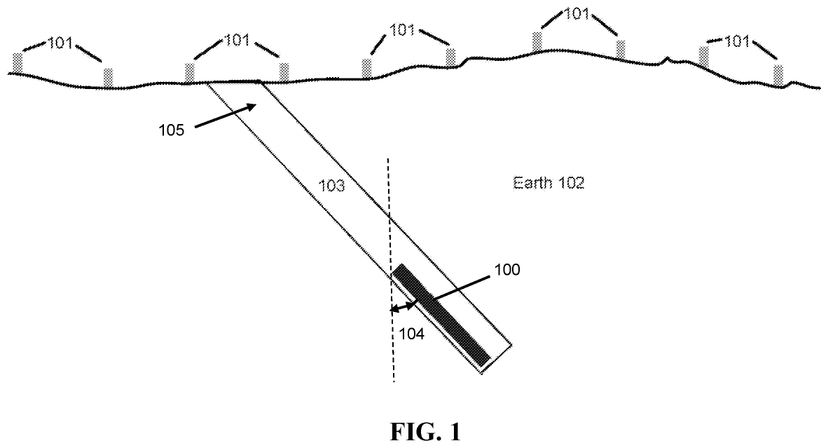

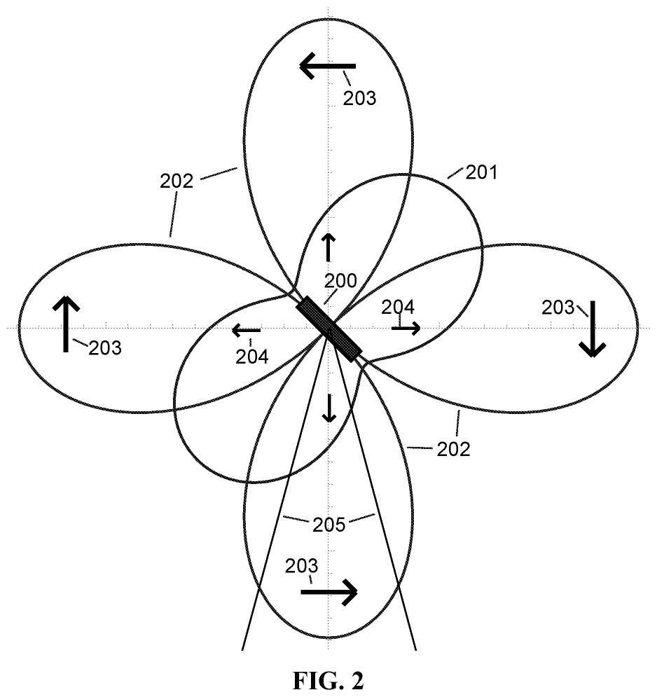

Methods and systems are disclosed to generate S-waves and Love waves from explosive sources in inclined boreholes and to record resulting waves on surface seismic receivers or borehole seismic receivers. FIG. 1 illustrates the environment of the borehole explosive 100 positioned in a borehole 105 and local surface seismic receivers 101. The borehole explosive and resulting explosion are referred to as the “shot”. Surface seismic receivers may extend tens of meters from the shot to hundreds of kilometers from shot depending on the size of the explosive charge and depth of investigation of the seismic survey. The borehole 105 for the shot is drilled into the earth 102 at an incline 104 which may be varied to obtain the specify objections of the survey. The resulting borehole 105 is loaded with explosives 100, grouted and stemmed 103 in an order which is operational appropriate. The objective of the grout and stemming 103 is to displace all fluid (air, water, and drilling fluids) from the borehole. When detonated the inclined borehole shot produces strong S-waves propagate downward and horizontally, see FIG. 2. Both FIG. 1 and FIG. 2 are drawn within the sagittal plane of the borehole explosive, that is the vertical plane that contains the explosive. The orientation of the sagittal plane is important when planning the drilling of the borehole to obtain the maximum amplitude of S-waves and Love waves with the desired polarizations.

FIG. 2 shows the directivity P-waves and S-waves generated, that is the amplitude of waves propagating in different directions, from an explosion 200 in an inclined cylindrical borehole. The directivity of the P-waves 201, as is the larger directivity of the S-waves 202. The polarizations of the S-waves 203 are horizontal for the down-going waves, the polarizations of the P-waves 204 are radial. Most of the energy useful in seismic reflection or refraction leaves the source in a narrow downward trajectory 205, which with the borehole inclined as described in this method produces a horizontal polarized S-wave 203.

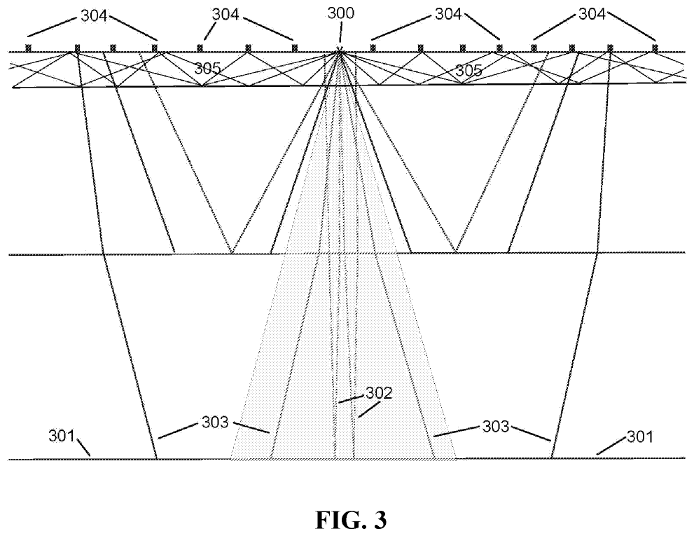

FIG. 3 is a drawing of rays of P-waves or S-waves emanating from a near-surface explosion 300 similar in design to shot hole in FIG. 1. For rays which reach deeper interfaces such as 301, the take-off angle is near-vertical. The rays are the source of near-vertical reflections 302 and refracted waves 303, both of which return to seismic receivers on the surface 304. These seismic waves correspond to the near-vertical directivity in 205. In addition, Love waves 305 are shown dispersing in a near-surface layer. These near-surface layers are invisible to body waves as are shallower reflections and refractions 306.

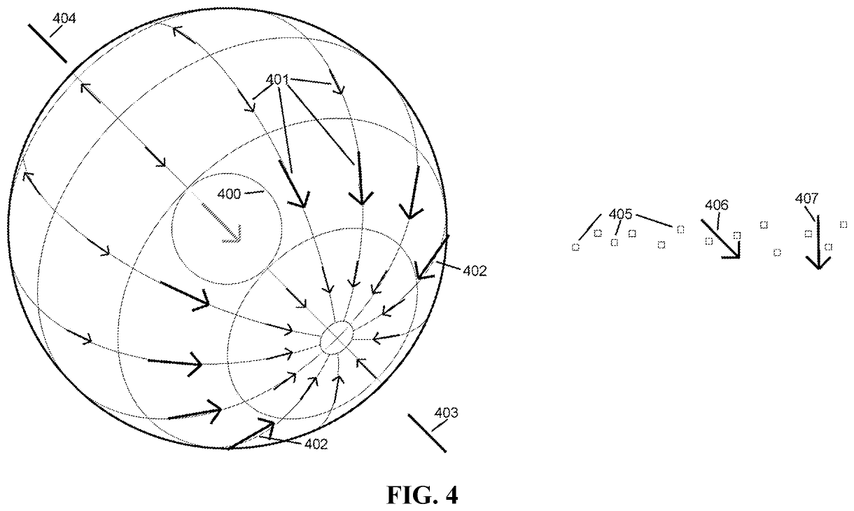

FIG. 4 is a stereographic projection of the lower half of the sphere surrounding the inclined shot in FIG. 1 and FIG. 2. The down-going energy that reaches the deeper interfaces such as 301, leaves the source in the small circle 400, other trajectories 401 are reflected or refracted back toward the surface 306 before reaching deeper interfaces. Shallow horizontal travelling S-waves which generate Love waves leave the source along near horizontal trajectories 402. The projection of the positive side of the sagittal plane 403 and the negative side 404 are also shown. Waves leave the source, travel deep within the earth FIG. 3, returning to receivers on the surface 405 with a vector sum polarization shown 406. Loves waves arrive on the same receiver array 405, but with polarization shown 407.

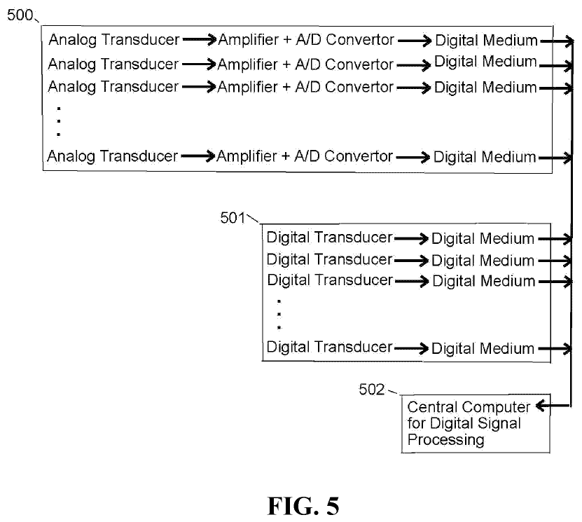

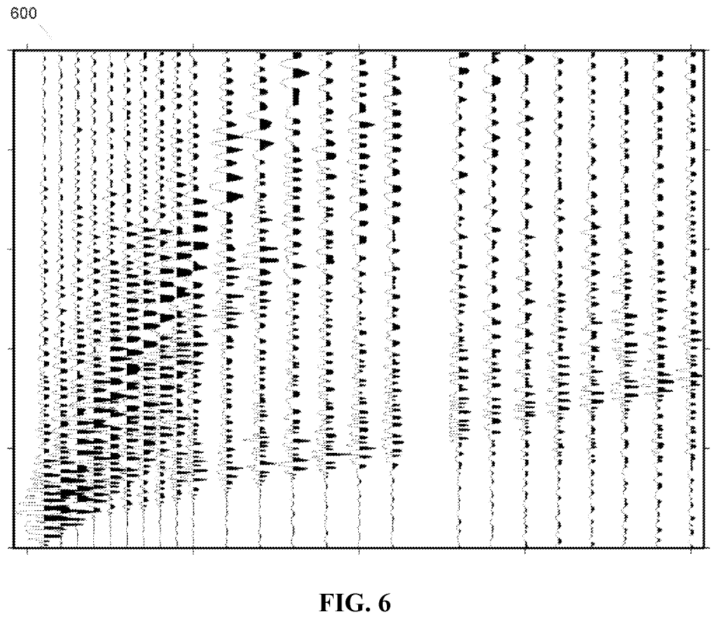

FIG. 5 is a schematic of a seismic recording system showing the components needed using an analog transducer, analog electronics, analog-to-digital convertor, and digital recording medium 500, alternatively using a digital transducer and digital recording medium 501. The transducers can sense one or multiple components of the ground motion at the receiver depending on their orientation. With either system the digital media are read into a central computer and digital signal processing is applied to these data. FIG. 6 shows example seismograms 600 collected with the seismic recording system in FIG. 5.

Explosive compositions can be varied to change the explosive density or detonation velocity, to match explosive byproduct impedance to the surrounding rock, to alter the energy release time, to change the total charge energy, or to change the partitioning of the total energy between shock and gas energy. Explosive forms can include, but are not limited to changes to the length, shape, and phase (whether liquid, gas, gel, emulsion, solid, particulate, or composite) of explosives or propellants. Nonlimiting examples of such explosives includes mixtures of PETN and TNT (“pentolite”), mixtures of TNT and other components such as aluminum (e.g., Tritonal), mixtures of PETN, TNT and other components, mixtures of PETN and TRITONAL, Composition B (mixtures of RDX (cyclonite), TNT and other components), Octol (mixtures of HMX and TNT), TNT/nitrate salt mixtures such as Amatol, castable or pourable plastic-bonded (PBX)-type compositions, RDX, HMX, fuel-oxidizer combinations in castable compositions and emulsion/slurry explosives. In particular applications pentolite and/or emulsions of ammonium nitrate solution in oil are used as explosives. Gelatin dynamites can be used as seismic sources. These dynamites are placed into three subcategories, straight gelatins in which nitroglycerin is the active component, ammonia gelatins in which ammonia nitrite is the active component, and semi gelatins in which the composition consists mostly of nitroglycerin. Typical charge sizes used in the field for reflection surveys are 0.25 kg to 1000 kg for single hole sources, 0.25 kg to 2500 kg or more for multiple hole sources and may reach 2500 kg or more for refraction surveys. In certain aspects the charge has a radius of 10, 20, 30, 40, 50, 60, 70, 80 cm, including all values and ranges there between, and a height of 50, 75, 100, 125, 150, 175, 200, 225, 250, 275, 300, 325, 350, 400 cm including all values and ranges there between. In certain aspects the charge has a radius to height ratio of 0.1, 1, 2, 3, 4, 5, 6, 7, 8, 9, 10 or more including all values and ranges there between. In certain aspects charge detonation is as instantaneous as possible. The detonation velocities can be 4000 m/s to 11000 m/s. In certain aspects the detonation velocity of the explosive charge is 5000 m/s to 7000 m/s. In certain aspects the explosive charge can be capped. The cap can be a bevel or form a point to aid in insertion of the explosive charge into the borehole.

Blast holes are often ‘stemmed’ by loading an inert material onto the explosive column to contain the energy released by detonation or minimize the loss of explosive energy out of the collar of the blast hole. The stemming or grouting is done to minimize the presence of water or other acoustic absorbing fluid in the borehole, ensuring proper conduction of acoustic waves to the formation or targeted area. Crushed rock is a commonly used stemming material. Drill cuttings, mud or clay (e.g., bentonite) are often used as alternatives. Grout can be used as a securing medium. Grout can be cement, e.g., Portland cement or a cement mixture (e.g., cement and inert material (e.g., bentonite) mixture). In certain aspects the grout is a mixture of cement and bentonite. In certain aspects the grout is selected to impedance match with explosive charge. An impedance matching problem exists when transferring sound energy from one medium to another. If the acoustic impedance of two media is very different sound energy can be reflected (or absorbed), rather than transferred across the border. Impedance matching assists in the transfer of acoustic energy generated by the explosive to the ground. In certain aspects the borehole is filled to the surface after placement of the explosive charge or before placement of the explosive charge. In other aspects the borehole is filled with enough cement to fix the charge.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be formed in the disclosed shapes, or combined in the disclosed configurations, but could be provided in any and all shapes, and/or combined in any and all configurations. The individual components need not be fabricated from the disclosed materials, but could be fabricated from any and all suitable materials. Homologous replacements may be substituted for the substances described herein. Agents which are both chemically and physiologically related may be substituted for the agents described herein where the same or similar results would be achieved.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

1. A method to generate S-waves and Love waves, comprising:
providing an inclined explosive source placed tightly in a borehole;
detonating the inclined explosive source;
orientating a polarization of S-waves and Love waves along an azimuth; and
acquiring signals by a plurality of receiver arrays which are autonomous or transmitted by cable or radio link to a recording medium.

2. The method in claim 1, further comprising grouting to couple the explosive to the borehole.

3. The method in claim 1, further comprising substantially eliminating fluid from a vicinity of the inclined explosive source.

4. The method in claim 1, further comprising stemming (material filling the borehole) above the inclined explosive source.

5. The method in claim 1, further comprising casing in the borehole.

6. The method in claim 1, further comprising using either solid or liquid explosive in the borehole.

7. The method in claim 1, wherein a plurality of seismic receiver arrays are on a surface.

8. The method in claim 1, wherein a plurality of seismic receiver arrays are located in boreholes.

9. The method in claim 1, wherein the borehole is drilled along straight or curved paths.

10. A method for generating S-waves and Love waves, comprising:
positioning an explosive source in a borehole at an incline;
securing the explosive source; and
detonating the explosive source to produce S-waves and Love waves.

11. The method of claim 10, wherein the incline is between 10 and 80 degrees.

12. The method of claim 11, wherein the incline is 45±5 degrees.

13. The method of claim 10, wherein in the explosive source is secured by stemming, grouting, or stemming and grouting.

14. The method of claim 10, wherein grouting uses a cement and bentonite mixture.

15. The method of claim 10, wherein the borehole includes a casing.

16. The method of claim 10, wherein the borehole is a curved borehole.

17. The method of claim 10, wherein the borehole is a straight borehole.

18. The method in claim 10, wherein the explosive is a solid explosive.

19. The method in claim 10, wherein the explosive is a liquid explosive.

20. The method of claim 10, wherein the explosive is positioned and/or shaped to orient a polarization of the S-waves and the Love waves along a desired azimuth.

21. The method of claim 10, further comprising detecting the S-waves and Love waves generated using seismic receiver arrays.

22. The method of claim 21, wherein the seismic receiver arrays are autonomous, cabled, or radio linked to a recording medium.

23. The method in claim 21, wherein the seismic receiver arrays are on a surface.

24. The method in claim 21, wherein the seismic receiver arrays are in secondary boreholes.
